(19) United States
(12) Patent Application Publication
(10) Pub. No.: US 2010/0165179 A1
(43) Pub. Date: Jul. 1, 2010

(54) IMAGING APPARATUS AND IMAGING METHOD

(75) Inventor: Kazuo KAWAMURA, Kurokawa-gun (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM Corporation, Toyko (JP)

(21) Appl. No.: 12/646,768

(22) Filed: Dec. 23, 2009

(30) Foreign Application Priority Data
Dec. 25, 2008 (JP) JP2008-330974
Oct. 22, 2009 (JP) JP2009-243684

(51) Int. Cl. H04N 5/222

(52) U.S. Cl. 348/371; 348/E05.022

(57) ABSTRACT

An imaging method for taking an image using an imaging apparatus including an imaging device which includes first rows of pixels including first groups of light receiving elements and second rows of pixels including second groups of light receiving elements; first charge transfer lines; and second charge transfer lines, includes steps of: consecutively performing a subject-illuminating imaging and a subject-non-illuminating imaging, responsive to an input of an imaging instruction; reading out the charges accumulated in the first groups and the second groups of light receiving elements, and transferring the charges via the first and second charge transfer lines, respectively, after the subject-illuminating imaging and the subject-non-illuminating imaging; and acquiring an image by the subject-illuminating imaging and an image by the subject-non-illuminating imaging from the charges having been read out and transferred from the first groups and the second groups of light receiving elements, respectively.

This application claims the priority benefit under 35 U.S.C. §119 of Japanese Patent Application No. 2008-330974 filed on Dec. 25, 2008 and Japanese Patent Application No. 2009-243684 filed on Oct. 22, 2009, which is hereby incorporated in its entirety by reference.

### BACKGROUND OF THE INVENTION

1. Field of the Invention

The presently disclosed subject matter relates to an imaging apparatus and an imaging method, and more particularly, to an imaging apparatus including a flash unit and an imaging method using the imaging apparatus.

2. Description of the Related Art

Japanese Patent Application Laid-Open No. 2004-54231 discloses a camera performing at least each one time of non-flash imaging with no flash firing and flash imaging with flash firing responsive to one shutter release operation.

Japanese Patent Application Laid-Open No. 2007-256907 discloses a digital camera including an imaging device which includes a special consecutive imaging mode of consecutively performing non-flash imaging and flash imaging responsive to one shutter release operation.

### SUMMARY OF THE INVENTION

In a case of consecutively performing subject-illuminating imaging which is an operation for taking an image of a subject while illuminating the subject by a flash unit and subject-non-illuminating imaging which is an operation for taking an image of the subject without illuminating the subject as described in Japanese Patent Applications Laid-Open Nos. 2004-54231 and 2007-256907, it is necessary to read out an image signal from an imaging device, and to transfer the image signal between the subject-illuminating imaging and the subject-non-illuminating imaging. Accordingly, there exists a time interval which cannot be negligible between the subject-illuminating imaging and the subject-non-illuminating imaging. Thus, the subject may move between the subject-illuminating imaging and the subject-non-illuminating imaging, and a position of the subject in an image taken by the subject-illuminating imaging may differ from (does not identical to) that of the subject-non-illuminating imaging. Therefore, simultaneity between images obtained by the subject-illuminating imaging and the subject-non-illuminating imaging may be lost.

The presently disclosed subject matter is made in view of such situations, and has an object to provide an imaging apparatus and an imaging method which can improve the simultaneity of images taken by subject-illuminating imaging and subject-non-illuminating imaging by reducing a time interval when consecutively performing the subject-illuminating imaging and the subject-non-illuminating imaging.

In order to solve the above-mentioned problem, an imaging apparatus according to a first aspect of the presently disclosed subject matter includes: an imaging device which includes first rows of pixels including first groups of light receiving elements disposed in a first direction and second rows of pixels including second groups of light receiving elements disposed in the first direction, the first and second rows of pixels being alternately disposed with respect to a second direction substantially perpendicular to the first direction; first charge transfer lines disposed corresponding to the first rows of the pixels, respectively, and for transferring charges accumulated in the first groups of light receiving elements; second charge transfer lines disposed corresponding to the second rows of the pixels, respectively, and for transferring charges accumulated in the second groups of light receiving elements; a flash device which flashes and illuminates a subject; an imaging instruction device which accepts an input of an imaging instruction; an imaging control device which, responsive to the input of the imaging instruction, consecutively performs a subject-illuminating imaging and a subject-non-illuminating imaging, reads out the charges accumulated in the first groups and the second groups of light receiving elements, and transfers the charges accumulated in the first groups and the second groups of light receiving elements via the first and second charge transfer lines, respectively, after the subject-illuminating imaging and the subject-non-illuminating imaging, the subject-illuminating imaging being an operation for taking an image of the subject by the first groups of light receiving elements while illuminating the subject by the flash device, and the subject-non-illuminating imaging being an operation for taking an image of the subject by the second groups of light receiving elements; and an image acquisition device which acquires an image by the subject-illuminating imaging and an image by the subject-non-illuminating imaging from the charges having been read out and transferred from the first groups and the second groups of light receiving elements, respectively.

According to the first aspect, the signal charges accumulated in the imaging device are read out in a separated fashion with respect to the first groups and the second groups, thereby transfer of the signal charges is not performed between the subject-illuminating imaging and the subject-non-illuminating imaging. Accordingly, a time interval of execution timing between the subject-illuminating imaging and the subject-non-illuminating imaging can be reduced. This can improve the simultaneity between the subject-illuminating imaging and the subject-non-illuminating imaging.

An imaging apparatus according to a second aspect of the presently disclosed subject matter is that of the first aspect, wherein the imaging control device, responsive to the input of the imaging instruction, causes the flash device to flash, starts an exposure on the imaging device and performs the subject-illuminating imaging, drains the charges accumulated in the second groups of light receiving elements after the subject-illuminating imaging, starts an exposure on the second groups of light receiving elements and performs the subject-non-illuminating imaging after draining the charges, reads out the charges accumulated in the first groups and the second groups of light receiving elements and transfers the charges through the first and the second charge transfer lines, respectively, after the subject-non-illuminating imaging has been finished.

According to the second aspect, the signal charges accumulated in the second groups are drained in midstream of an exposure of the subject-illuminating imaging, and the exposure of the subject-non-illuminating imaging is performed. Accordingly, a time interval of execution timing between the subject-illuminating imaging and the subject-non-illuminating imaging can be minimized.

An imaging apparatus according to a third aspect of the presently disclosed subject matter is that of the second aspect, wherein the imaging control device controls start timing of the second groups of light receiving elements such that exposure time periods of the first groups and the second groups of light receiving elements lapse at the same time.

An imaging apparatus according to a fourth aspect of the presently disclosed subject matter is that of the first aspect, wherein the imaging control device, responsive to the input of the imaging instruction, starts an exposure on the imaging device and performs the subject-illuminating imaging, reads out the charges accumulated in the first groups of light receiving elements on the first charge transfer lines after the subject-illuminating imaging has been finished, starts an exposure on the imaging device and performs the subject-non-illuminating imaging after reading out the charges from the first groups of light receiving elements, reads out the charges from the second groups of light receiving elements after the subject-non-illuminating imaging has been finished, and transfers the charges having been read out from the first groups and the second groups of light receiving elements through the first and the second charge transfer lines, respectively.

According to the fourth aspect, transfer of the signal charges is not performed between the subject-illuminating imaging and the subject-non-illuminating imaging. Accordingly, a time interval of execution timing between the subject-illuminating imaging and the subject-non-illuminating imaging can be reduced.

An imaging apparatus according to fifth aspect of the presently disclosed subject matter further includes, in addition to the configuration of any one of the first to fourth aspect, an image combining device which combines the image acquired by the subject-illuminating imaging and the image acquired by the subject-non-illuminating imaging.

According to the first to fifth aspects, high simultaneity can be achieved between the subject-illuminating imaging and the subject-non-illuminating imaging, and an amount of displacement between the subject in the images obtained by the subject-illuminating imaging and the subject-non-illuminating imaging, thereby improvement in accuracy of combining images and reduction in load on the composite process can be compatibly actualized.

An imaging method according to a sixth aspect of the presently disclosed subject matter for taking an image using an imaging apparatus including an imaging device which includes first rows of pixels including first groups of light receiving elements disposed in a first direction and second rows of pixels including second groups of light receiving elements disposed in the first direction, the first and second rows of pixels being alternately disposed with respect to a second direction substantially perpendicular to the first direction; first charge transfer lines disposed corresponding to the first rows of the pixels, respectively, and for transferring charges accumulated in the first groups of light receiving elements; and second charge transfer lines disposed corresponding to the second rows of the pixels, respectively, and for transferring charges accumulated in the second groups of light receiving elements, includes: an imaging step of consecutively performing a subject-illuminating imaging and a subject-non-illuminating imaging, responsive to an input of an imaging instruction, the subject-illuminating imaging being an operation for taking an image of the subject by the first groups of light receiving elements while illuminating the subject by the flash device, and the subject-non-illuminating imaging being an operation for taking an image of the subject by the second groups of light receiving elements; a transfer step of reading out the charges accumulated in the first groups and the second groups of light receiving elements, and transferring the charges via the first and second charge transfer lines, respectively, after the subject-illuminating imaging and the subject-non-illuminating imaging; and an image acquisition step of acquiring an image by the subject-illuminating imaging and an image by the subject-non-illuminating imaging from the charges having been read out and transferred from the first groups and the second groups of light receiving elements, respectively.

An imaging method according to seventh aspect of the presently disclosed subject matter is that of the sixth aspect, wherein the imaging step includes: a step of causing the flash device to flash, starting an exposure on the imaging device and performing the subject-illuminating imaging; a step of draining the charges accumulated in the second groups of light receiving elements after the subject-illuminating imaging has been finished; a step of starting an exposure on the second groups of light receiving elements and performing the subject-non-illuminating imaging after draining the charges; and a step of reading out and transferring the charges from the first groups and the second groups of light receiving elements through the first and the second charge transfer lines, respectively, after the subject-illuminating imaging and the subject-non-illuminating imaging has been finished.

An imaging method according to an eighth aspect of the presently disclosed subject matter is that of the seventh aspect further including a step of controlling exposure start timing of the second groups of light receiving elements such that exposure time periods of the first groups and the second groups of light receiving elements lapse at the same time.

An imaging method according to a ninth aspect of the presently disclosed subject matter is that of the sixth aspect, wherein the imaging step includes: a step of causing the flash device to flash, starting an exposure on the imaging device and performing the subject-illuminating imaging; a step of reading out the charges accumulated in the first groups of light receiving elements on the first charge transfer lines after the subject-illuminating imaging has been finished; a step of starting an exposure on the imaging device and performing the subject-non-illuminating imaging after reading out the charges from the first groups of light receiving elements; a step of reading out the charges from the second groups of light receiving elements after the subject-non-illuminating imaging has been finished; and a step of transferring the charges having been read out from the first groups and the second groups of light receiving elements through via the first and the second charge transfer lines, respectively.

An imaging method according to a tenth aspect of the presently disclosed subject matter is that of any one of the sixth to ninth aspects further including an image combining step of combining the image acquired by the subject-illuminating imaging and the image acquired by the subject-non-illuminating imaging.

According to the presently disclosed subject matter, the signal charges accumulated in the imaging device are read out in a separated fashion with respect to the first groups and the second groups, and transfer of the signal charges is not performed between the subject-illuminating imaging and the subject-non-illuminating imaging. Therefore, a time interval of execution timing between the subject-illuminating imaging and the subject-non-illuminating imaging can be reduced, and the simultaneity between the subject-illuminating imaging and the subject-non-illuminating imaging may be improved.

### BRIEF DESCRIPTION OF THE DRAWINGS

FIG. 1 is a block diagram showing an electronic camera of a first embodiment of the presently disclosed subject matter;

FIG. 2 is a plan view schematically showing an imaging device 24;

FIG. 3 is a timing chart showing the first embodiment of a method for driving the imaging device in a consecutive imaging mode;

FIG. 4 is a timing chart showing a second embodiment of a method for driving the imaging device in a consecutive imaging mode; and

FIGS. 5A to 5D are diagrams illustrating processing of combining an image by subject-illuminating imaging and an image by subject-non-illuminating image.

### DETAILED DESCRIPTION OF THE PREFERRED EMBODIMENTS

The preferred embodiments of an imaging apparatus and an imaging method according to the presently disclosed subject matter will hereinafter described with reference to the accompanying drawings.

### First Embodiment

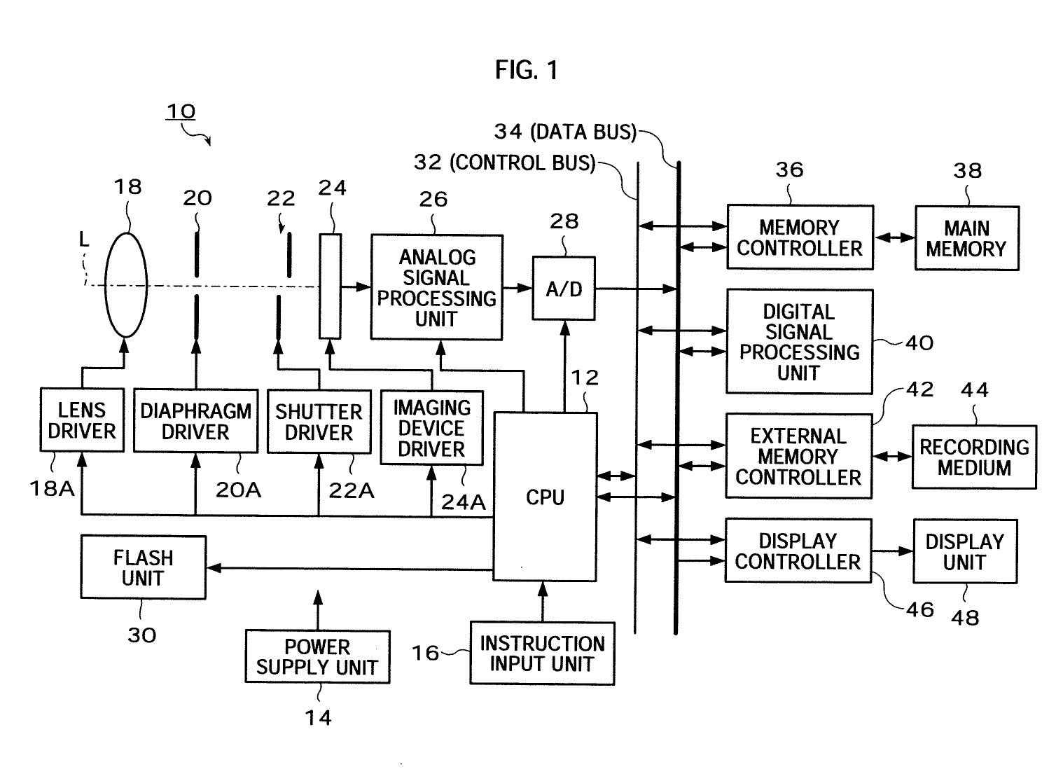

FIG. 1 is a block diagram showing an electronic camera of a first embodiment of the presently disclosed subject matter.

The electronic camera 10 of this embodiment includes a function of imaging and a function of reproducing and displaying a still image and a moving image.

A CPU (Central Processing Unit) 12 outputs an instruction to components of the electronic camera 10 via a control bus 32, and controls operation of the electronic camera 10.

The control bus 32 is a transmission line through which the instruction from the CPU 12 is transmitted to the components of the electronic camera 10. A data bus 34 is a transmission line through which various pieces of data such as an image signal are transmitted.

A power supply unit 14 includes a battery and a power supply circuit which converts electric power supplied by the battery into a prescribed voltage current, and supplies the current to the components of the electronic camera 10.

An instruction input unit 16 receives an instruction input by a user, and includes, for instance, a power switch for switching the power on and off, a release button accepting an input of an instruction for taking an image, a zoom button receiving a zoom instruction, and a mode selection switch accepting an instruction for switching operation modes of the electronic camera 10 between an imaging mode for taking an image and a playback mode for reproducing and displaying an image. The CPU 12 recognizes a content of an instruction input to the instruction input unit 16 by the user, and controls the components of the electronic camera 10.

A recording medium 44 is detachable to the electronic camera 10, and, for instance, is the SD Memory Card (registered trademark) or the xD-Picture Card (registered trademark).

A display unit 48 includes a liquid crystal monitor capable of displaying colors. The display unit 48 functions as an electronic viewfinder for confirming the angle of view when taking an image, and functions as a device which reproduces and displays a recorded image. The display unit 48 also functions as a display screen for a user interface, and displays, for instance, menu information and information of various selection items and set contents. A display device of another system (e.g., organic EL (electroluminescence) display) can be used as the display unit 48 instead of the liquid crystal monitor.

When the operation mode of the electronic camera 10 is set to the imaging mode, the power is supplied to the imaging unit including an imaging device 24, and the camera becomes a status capable of imaging. As shown in FIG. 1, the electronic camera 10 includes an imaging lens 18, a diaphragm 20, a mechanical shutter 22, the imaging device 24 and a flash unit 30.

The imaging lens 18 includes a zoom lens and a focusing lens. The CPU 12 performs a zoom control by controlling a lens driver 18A to adjust the position of the zoom lens, responsive to an input from the zoom button. The CPU 12 performs a focusing control by controlling the lens driver 18A to adjust the position of the focusing lens. The CPU 12 adjusts an amount of light to enter the imaging device 24 while the imaging device 24 is exposed to the light by controlling a diaphragm driver 20A to adjust an amount of aperture of the diaphragm 20. When reading out data from the imaging device 24, the CPU 12 shuts the mechanical shutter 22 by instructing the shutter driver 22A. Then, the light to enter the imaging device 24 is shut off when reading out the data.

The flash unit 30 includes a light emitter (e.g., electric discharge tube (xenon tube) or light-emitting diode) which emits light when taking an image to illuminate the subject, and a capacitor which stores electrical energy which is supplied to the light emitter.

The imaging device 24 is, for instance, a CCD (Charge Coupled Device) image sensor. An imaging device of another system (e.g., CMOS (Complementary Metal Oxide Semiconductor) image sensor) can be used for the imaging device 24 instead of the CCD.

Subject light having passed through the imaging lens 18 forms an image on a light acceptance surface of the imaging device 24. There are a plurality of light receiving elements (photodiodes) attached with color filters of, for instance, the three primary colors of red (R), green (G) and blue (B), on the light acceptance surface of the imaging device 24. A combination of color filters other than the three primary colors (e.g., complementary colors) can be used.

The CPU 12 drives the imaging device 24 by controlling an imaging device driver 24A, converts the subject light which formed an image on the light acceptance surface into signal charges (color signal) corresponding to the three primary colors of R, G and B, and reads out the signal charges. The analog color signal having been read out from the imaging device 24 is sampled and held (correlated double sampling process) by an analog signal processing unit 26, and amplified. Subsequently, the amplified color signal is converted into a digital R, G and B signal by an A/D (analog to digital) converter 28. An amplification gain of the R, G and B signal in the analog signal processing unit 26 corresponds to a photographic sensitivity (ISO (International Organization for Standardization) sensitivity). The CPU 12 sets the photographic sensitivity by adjusting the amplification gain according to subject brightness and the like.

The above-mentioned digital R, G and B signal is stored in a main memory 38 via the data bus 34. A memory controller 36 performs a prescribed signal conversion according to an instruction from the CPU 12 when inputting and outputting the data at the main memory 38.

The digital signal processing unit 40 applies a prescribed signal processing (e.g., a color-interpolating process, gradation conversion process (gamma correction process), contour correction process and white balance adjustment process) to the digital R, G and B signals stored in the main memory 38. The digital signal processing unit 40 converts the digital R, G and B signals into a brightness signal (Y signal) and color difference signals (Cr and Cb signals), according to an instruction from the CPU 12.

When a live view image (live preview image) is displayed on the display unit 48, the brightness signal and the color difference signals (hereinafter referred to as a Y/C signal) generated in the digital signal processing unit 40 is converted into the R, G and B signal on a frame-by-frame basis. Subsequently, the converted R, G and B signal is outputted to the display unit 48.

Next, an imaging process in the electronic camera 10 will be described. When detecting the release button is half-pressed (S1-on), the CPU 12 starts an imaging preparation process (e.g., an automatic exposure process (AE) and an automatic focus adjustment process (AF)). The CPU 12 integrating accumulates the digital R, G and B signal stored in the main memory 38 on a prescribed division area basis. The CPU 12 then calculates an exposure value (imaging exposure value (EV)) on the basis of the integrating accumulated value of the R, G and B signal, and adjusts the aperture value and the shutter speed according to a prescribed program diagram. The CPU 12 controls modulation of a light by controlling the flash unit 30.

The CPU 12, for instance, acquires a position where a high frequency component of the G signal in the image signal reaches a local maximum as an in-focus position. The CPU 12 causes the focusing lens to move to the in-focus position by outputting an instruction to the lens driver 18A.

When performing an automatic white balance adjustment process (AWB), the CPU 12 calculates an average integrating accumulated values on each of the R, G and B signal on a prescribed division area basis. The CPU 12 distinguishes a light source type based on the average integrating accumulated values of the R, G and B signal calculated on a division area basis, and controls a white balance gain to the R, G and B signal based on the distinguished light source type.

After the AE process and the AF process have been performed responsive to the half-press of the release button (S1-on), a full-press of the release button (S2-on) starts an imaging operation for recording. Image data having been acquired responsive to the “S2-on” is converted into a Y/C signal by the digital signal processing unit 40, subjected to a prescribed process such as a gamma correction, and subsequently stored in the main memory 38.

The Y/C signal stored in the main memory 38 is compressed according to a prescribed format, and subsequently recorded in the recording medium 44 via an external memory controller 42. A still image and a moving image are recorded as, for instance, image files pursuant to the JPEG (Joint Photographic Experts Group) format and the AVI (Audio Video Interleaving) format, respectively.

When the operation mode of the electronic camera 10 is set to the playback mode, a prescribed image file recorded in the recording medium 44 (e.g., the image file recorded last in the recording medium 44) is read out. When the read image file is still image file, the compressed image data in the image file read out from the recording medium 44 is decompressed into an uncompressed Y/C signal, converted into a signal for displaying by a display controller 46, and subsequently outputted to the display unit 48. The image having been stored in the image file is thus displayed on the screen of the display unit 48.

[Imaging Device]

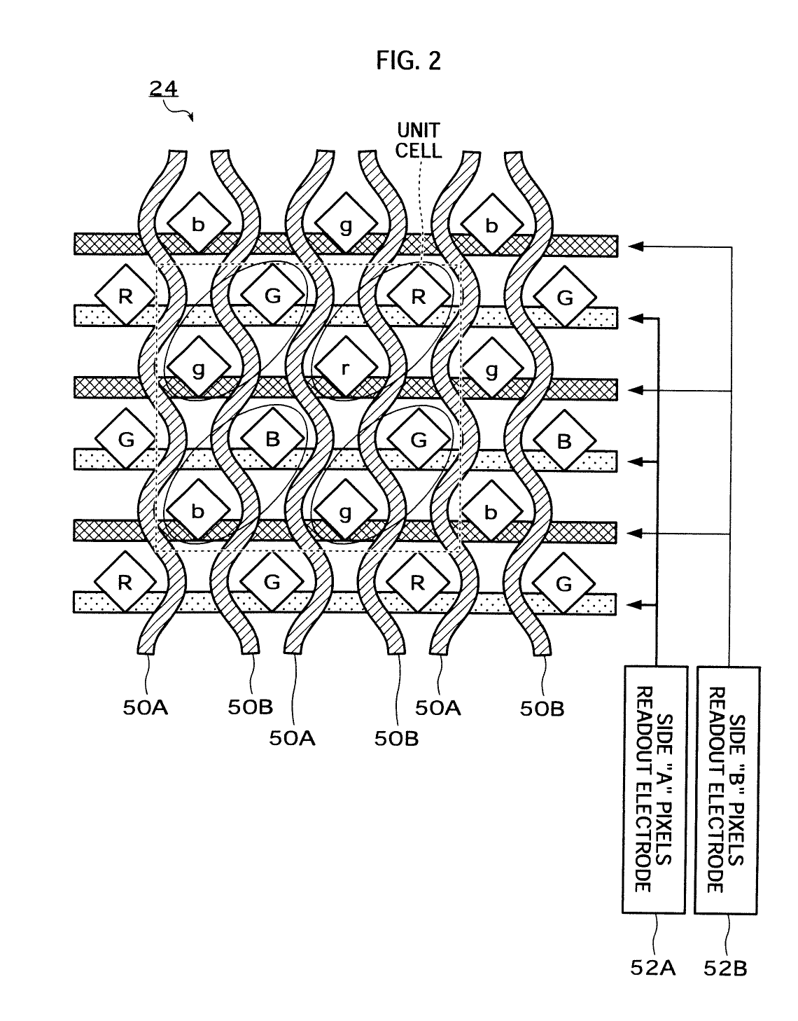

FIG. 2 is a plan view schematically showing the imaging device 24.

As shown in FIG. 2, a plurality of light receiving elements attached with color filters of the three primary colors, that is red (R), green (G) and blue (B), are disposed on the light acceptance surface of the imaging device 24. In FIG. 2, pixels with an uppercase character “R”, “G” or “B” are pixels on a side “A”, and pixels with a lowercase character “r”, “g” or “b” are pixels on a side “B”. The disposition of the pixels of the presently disclosed subject matter is not limited to the example shown in FIG. 2. For example, pixels with color filters of R, G and B on a side “A” and a side “B” may be arranged alternately.

As shown in FIG. 2, each of the side “A” and the side “B” includes color filters of the three primary colors R, G and B, and a full color image can be generated by the color signals read out from only one of the side “A” and the side “B”.

As shown in FIG. 2, the imaging device 24 includes charge transfer lines 50A and 50B dedicated for transferring the signal charges read out from the pixels on the side “A” and “B” respectively, and readout electrodes 52A and 52B dedicated for applying a driving pulse to the charge transfer lines 50A and 50B respectively. Accordingly, each of signal charges accumulated in the pixels on the side “A” and signal charges accumulated in the pixels on the side “B” can be readout and transferred separately, or not in synchronous manner.

[Method for Driving Imaging Device]

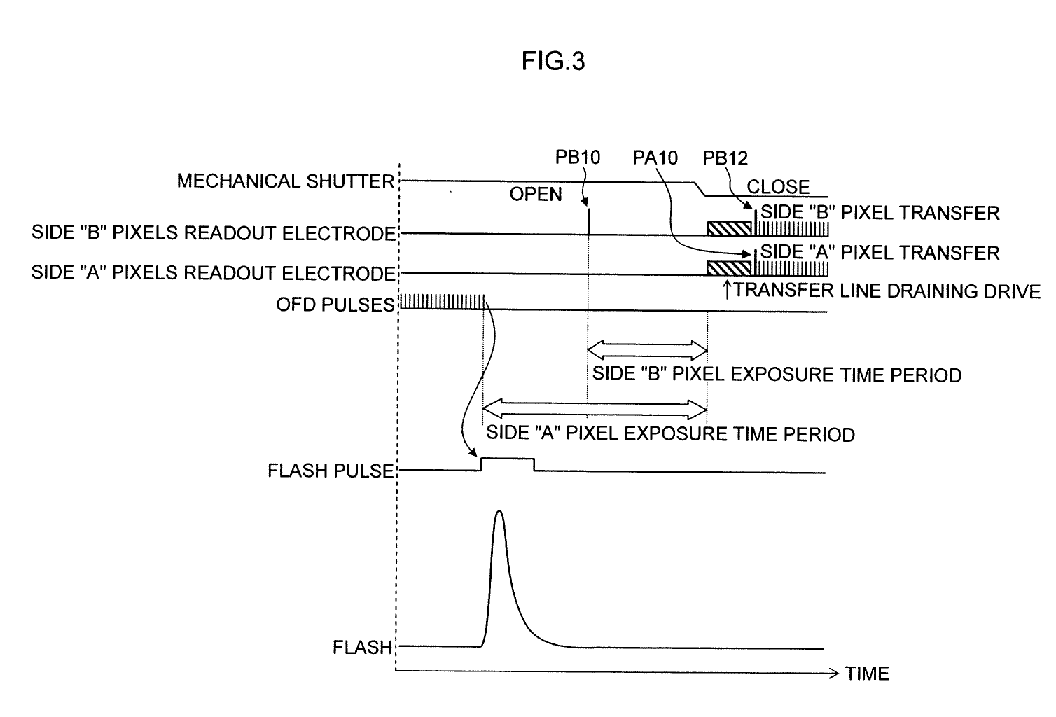

A method for driving the imaging device in a consecutive imaging mode will hereinafter be described with reference to a timing chart shown in FIG. 3.

The electronic camera 10 according to this embodiment has the consecutive imaging mode for consecutively performing a subject-illuminating imaging and a subject-non-illuminating imaging responsive to one press of the release button (S2-on). The subject-illuminating imaging is an operation for taking an image of a subject while illuminating the subject by the flash unit 30. The subject-non-illuminating imaging is an operation for taking an image of the subject without a flash by the flash unit 30 or at a time when an influence of a flash has sufficiently been slight after a flash by the flash unit 30. On the subject-non-illuminating imaging in the consecutive imaging mode, the image is taken under a different imaging condition (e.g., a different exposure, or different photographic sensitivity (a photographic sensitivity higher than that of the subject-illuminating imaging)) from that of the subject-illuminating imaging. Here, the time when an influence of a flash has sufficiently been slight is, for instance, a time when the absolute value of a difference between a brightness of the subject (e.g., the subject in-focus, main subject) and a brightness of the subject before a flash by the flash unit 30 has become smaller than or equal to a prescribed value. A time interval (timing allowing the pixels in the side “B” to be exposed, hereinafter referred to as a timing capable of starting exposure) in which the difference becomes smaller or equal to the prescribed value may be measured on each distance (subject distance) from the electronic camera 10 to the subject, and preliminary recorded in the main memory 38 of the electronic camera 10. The timing capable of starting exposure can be acquired by retrieving data of the timing capable of starting exposure in the main memory 38 using the subject distance acquired by the imaging preparation process (AF process) when taking an image.

First of all, before exposure, OFD (Overflow Drain) pulses are applied by the imaging device driver 24A to the imaging device 24, and charges accumulated in the pixels are drained to a side of a substrate on which the imaging device 24 is disposed, as shown in FIG. 3. Responsive to a half-press of the release button (S1-on), the above-mentioned imaging preparation process is executed, and the exposure time periods of the subject-illuminating imaging and the subject-non-illuminating imaging are determined.

Next, responsive to a full-press of the release button (S2-on), the application of the OFD pulses is terminated, and a flash pulse is outputted to the flash unit 30. Then, the flash unit 30 flashes, and the exposure on the pixels on the side “A” of the imaging device 24 starts. When the flash by the flash unit 30 has finished, a signal charge transfer pulse PB10 is applied to the imaging device 24 from the imaging device driver 24A via a side “B” pixels readout electrode 52B, and the signal charges accumulated in the pixels on the side “B” are read out through the charge transfer line 50B.

Subsequently, an exposure on the pixels on the side “B” starts. The timing of starting the exposure on the pixels on the side “B” is adjusted such that an exposure time period of the pixels on the side “A” and an exposure time period of the pixels on the side “B” are substantially lapsed at the same time.

Next, when the exposure time periods of the pixels of the side “A” and the pixels on the side “B” determined in the above-mentioned imaging preparation process (AE process) has lapsed, the mechanical shutter 22 is shut. And then, a draining drive is performed in order to drain charges remaining in the charge transfer lines 50A and 50B. Signal charge transfer pulses PA10 and PB12 are then applied to the imaging device 24 from the imaging device driver 24A via the image readout electrodes 52A and 52B, respectively, and the signal charges accumulated in the pixels on the side “A” and the pixels on the side “B” are separately transferred and read out.

Next, the signal charges having been read out from the pixels on the side “A” and the pixels on the side “B” are separately processed, and image data by the subject-illuminating imaging and image data by the subject-non-illuminating imaging are created from the signal charges read out from the pixels on the side “A” and the pixels on the side “B”, respectively.

According to this embodiment, the pixels of the imaging device 24 are separated into the side “A” and the side “B”, and the signal charges accumulated in the pixels on the side “A” and the side “B” are read out separately. Therefore, readout out and transfer of the signal charges are not performed between the subject-illuminating imaging and the subject-non-illuminating imaging. Accordingly, a time interval of execution timing between the subject-illuminating imaging and the subject-non-illuminating imaging can be minimized. This embodiment improves the simultaneity between the subject-illuminating imaging and the subject-non-illuminating imaging.

The image acquired from the pixels on the side “A” and the image acquired from the pixels on the side “B” can be combined. In this case, according to the embodiment, the simultaneity between the subject-illuminating imaging and the subject-non-illuminating imaging is improved, and the amount of displacement of the subject between each imaging is smaller. Therefore, the embodiment can reduce the amount of processing in the composite process on the images.

### Second Embodiment

Next, a second embodiment of the presently disclosed subject matter will be described. It should be noted that the description on the same configuration as that of the above-mentioned first embodiment will be omitted.

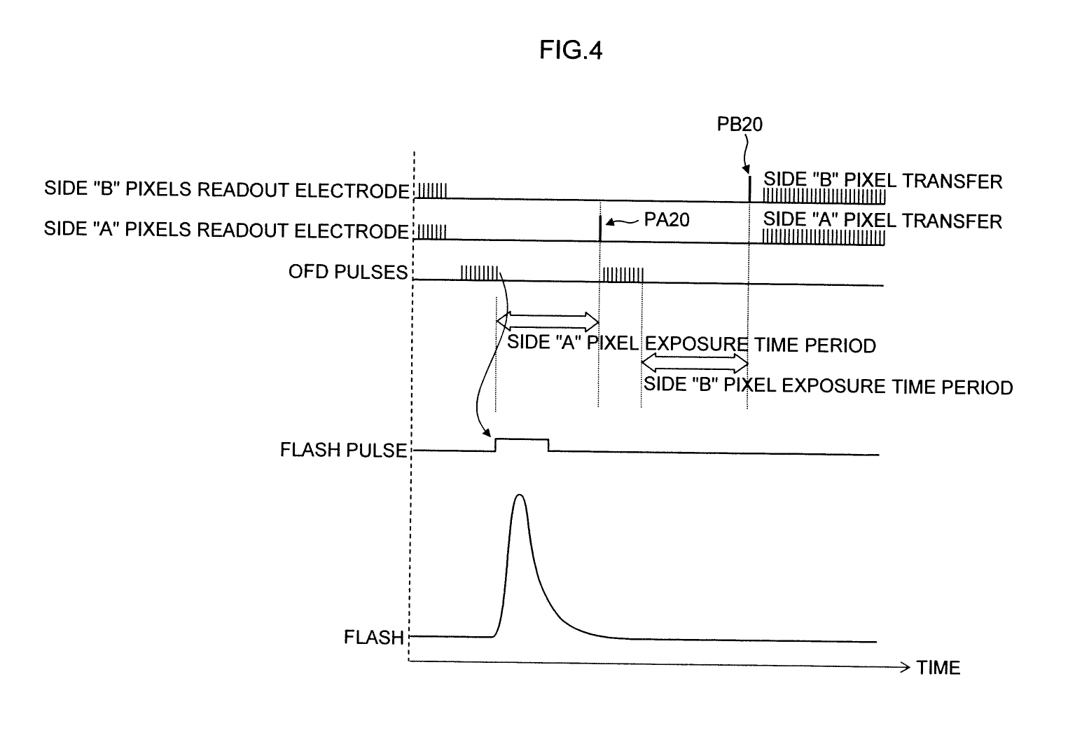

FIG. 4 is a timing chart showing the second embodiment of a method for driving the imaging device in the consecutive imaging mode.

First of all, before exposure, OFD pulses are applied by the imaging device driver 24A to the imaging device 24, and charges accumulated in the pixels are drained to a side of the substrate on which the imaging device 24 is disposed, as shown in FIG. 4. Responsive to a half-press of the release button (S1-on), the above-mentioned imaging preparation process is executed, and the exposure time periods of the subject-illuminating imaging and the subject-non-illuminating imaging are determined.

Next, responsive to a full-press of the release button (S2-on), the application of the OFD pulses is terminated, and a flash pulse is outputted to the flash unit 30. Then, the flash unit 30 flashes, and the exposure on the pixels on the side “A” of the imaging device 24 starts. When the flash by the flash unit 30 has finished and the exposure time period on the pixels on the side “A” has lapsed, a signal charge transfer pulse PA20 is applied to the imaging device 24 from the imaging device driver 24A via a side “A” pixels readout electrode 52A. Then, the signal charges accumulated in the pixels on the side “A” are read out on the charge transfer line 50A.

Next, OFD pulses are applied by the imaging device driver 24A to the imaging device 24, and charges accumulated in the pixels of the imaging device 24 are drained. Subsequently, an exposure on the pixels on the side “B” starts. When the exposure time period on the pixels on the side “B” has lapsed, a signal charge transfer pulse PB20 is applied to the imaging device 24 from the imaging device driver 24A via a side “B” pixels readout electrode 52B. Then, the signal charges accumulated in the pixels on the side “B” are read out on the charge transfer line 50B.

Next, the signal charges having read out from the pixels on the side “A” and the pixels on the side “B” are separately transferred through the charge transfer line 50A and 50B, respectively, and processed. Image data by the subject-illuminating imaging and image data by the subject-non-illuminating imaging are created from the signal charges read out from the pixels on the side “A” and the pixels on the side “B”, respectively.

According to this embodiment, the pixels of the imaging device 24 are separated into the side “A” and the side “B”, and the signal charges accumulated in the pixels on the side “A” and the side “B” are read out separately. Therefore, transfer of the signal charges is not performed between the subject-illuminating imaging and the subject-non-illuminating imaging. Accordingly, a time interval of execution timing between the subject-illuminating imaging and the subject-non-illuminating imaging can be minimized. Furthermore, according to this embodiment, the exposure time periods of the subject-illuminating imaging and the subject-non-illuminating imaging can be separately controlled and set to the most appropriate values. For example, the exposure time period on the subject-illuminating imaging is shorter than the exposure time period on the subject-non-illuminating imaging, thereby the exposure time periods on each imaging which are thought to be most appropriate can be determined.

In this embodiment, the subject-illuminating imaging and the subject-non-illuminating imaging can repeatedly be executed. In this case, a moving image by the subject-illuminating imaging and a moving image by the subject-non-illuminating imaging can be acquired by one camera. Such embodiment is useful as a monitoring camera.

[Process for Combining Images]

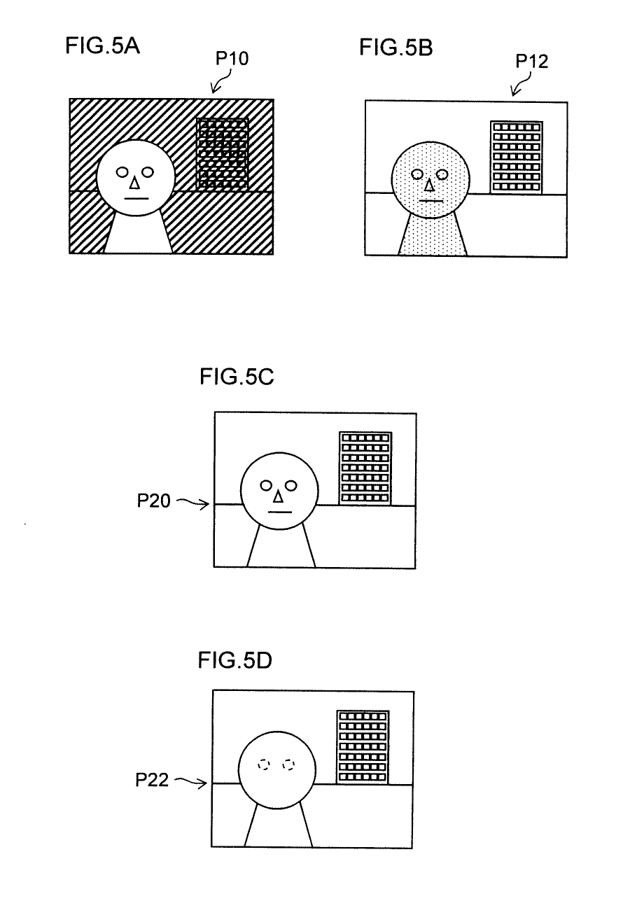

Next, a processing of combining an image by subject-illuminating imaging and an image by subject-non-illuminating image obtained in the above-mentioned embodiment will be described with reference to FIGS. 5A to 5D.

An image P10 shown in FIG. 5A is an image by subject-illuminating imaging. In the image P10, a main subject (person) in a region that flash light can reach is imaged brightly and sharply, and the background (scene such as buildings) that flash light can not reach is darkly imaged.

An image P12 shown in FIG. 5B is an image by subject-non-illuminating imaging, and the exposure time period is set longer or the photographic sensitivity is set higher than that of the image P10. In the image P12, the background is brighter and sharper than that of the image P10. However, the main subject is imaged darker due to for instance imaging conditions having been slightly backlight.

An image P20 shown in FIG. 5C is an image generated by extracting the main subject (person) from the image P10 by the subject-illuminating imaging, extracting the background from the image P12 by the subject-non-illuminating imaging and combining the extracted images of the main subject and the background. In the image P20, both of the main subject and the background are bright and sharp.

On the other hand, the image P22 shown in FIG. 5D is an image generated by simply adding the image data of the images P10 to that of the image P12. Since it is generally difficult to make the main subject have the most appropriate brightness by a simple method such as the simple addition, the image P22 has a slight whiteout at the main subject in comparison with the image P20. Accordingly, it is difficult to distinguish features of the person, that is, the main subject.

If the time interval between the subject-illuminating imaging and the subject-non-illuminating imaging is long, the subject may sometimes displace. A high degree of image processing such as correction of the amount of displacement of the subject is thus required when the images acquired by the subject-illuminating imaging and the subject-non-illuminating imaging are combined. This increases the load of processing for combining the images. The presently disclosed subject matter can improve the simultaneity between each imaging and reduce the displacement of the subject, thereby obviating the necessity of the heavy load of processing. Therefore, the presently disclosed subject matter allows the composite image to be acquired by a simple processing.

While there has been described what are at present considered to be exemplary embodiments of the invention, it will be understood that various modifications may be made thereto, and it is intended that the appended claims cover such modifications as fall within the true spirit and scope of the invention. All conventional art references described above along with any English translations thereof are herein incorporated in their entirety by reference.

What is claimed is:

1. An imaging apparatus, comprising:
an imaging device which includes first rows of pixels including first groups of light receiving elements disposed in a first direction and second rows of pixels including second groups of light receiving elements disposed in the first direction, the first and second rows of pixels being alternately disposed with respect to a second direction substantially perpendicular to the first direction;
first charge transfer lines disposed corresponding to the first rows of the pixels, respectively, and for transferring charges accumulated in the first groups of light receiving elements;
second charge transfer lines disposed corresponding to the second rows of the pixels, respectively, and for transferring charges accumulated in the second groups of light receiving elements;
a flash device which flashes and illuminates a subject;
an imaging instruction device which accepts an input of an imaging instruction;
an imaging control device which, responsive to the input of the imaging instruction, consecutively performs a subject-illuminating imaging and a subject-non-illuminating imaging, reads out the charges accumulated in the first groups and the second groups of light receiving elements, and transfers the charges accumulated in the first groups and the second groups of light receiving elements via the first and second charge transfer lines, respectively, after the subject-illuminating imaging and the subject-non-illuminating imaging, the subject-illuminating imaging being an operation for taking an image of the subject by the first groups of light receiving elements while illuminating the subject by the flash device, and the subject-non-illuminating imaging being an operation for taking an image of the subject by the second groups of light receiving elements; and
an image acquisition device which acquires an image by the subject-illuminating imaging and an image by the subject-non-illuminating imaging from the charges having been read out and transferred from the first groups and the second groups of light receiving elements, respectively.

2. The imaging apparatus according to claim 1, wherein the imaging control device, responsive to the input of the imaging instruction, causes the flash device to flash, starts an exposure on the imaging device and performs the subject-illuminating imaging, drains the charges accumulated in the second groups of light receiving elements after the subject-illuminating imaging, starts an exposure on the second groups of light receiving elements and performs the subject-non-illuminating imaging after draining the charges, reads out the charges accumulated in the first groups and the second groups of light receiving elements and transfers the charges through the first and the second charge transfer lines, respectively, after the subject-non-illuminating imaging has been finished.

3. The imaging apparatus according to claim 2, wherein the imaging control device controls start timing of the second groups of light receiving elements such that exposure time periods of the first groups and the second groups of light receiving elements lapse at the same time.

4. The imaging apparatus according to claim 1, wherein the imaging control device, responsive to the input of the imaging instruction, starts an exposure on the imaging device and performs the subject-illuminating imaging, reads out the charges accumulated in the first groups of light receiving elements on the first charge transfer lines after the subject-illuminating imaging has been finished, starts an exposure on the imaging device and performs the subject-non-illuminating imaging after reading out the charges from the first groups of light receiving elements, reads out the charges from the second groups of light receiving elements after the subject-non-illuminating imaging has been finished, and transfers the charges having been read out from the first groups and the second groups of light receiving elements through the first and the second charge transfer lines, respectively.

5. The imaging apparatus according to claim 1, further comprising an image combining device which combines the image acquired by the subject-illuminating imaging and the image acquired by the subject-non-illuminating imaging.

6. An imaging method for taking an image using an imaging apparatus comprising an imaging device which includes first rows of pixels including first groups of light receiving elements disposed in a first direction and second rows of pixels including second groups of light receiving elements disposed in the first direction, the first and second rows of pixels being alternately disposed with respect to a second direction substantially perpendicular to the first direction; first charge transfer lines disposed corresponding to the first rows of the pixels, respectively, and for transferring charges accumulated in the first groups of light receiving elements; and second charge transfer lines disposed corresponding to the second rows of the pixels, respectively, and for transferring charges accumulated in the second groups of light receiving elements, comprising:
an imaging step of consecutively performing a subject-illuminating imaging and a subject-non-illuminating imaging, responsive to an input of an imaging instruction, the subject-illuminating imaging being an operation for taking an image of the subject by the first groups of light receiving elements while illuminating the subject by the flash device, and the subject-non-illuminating imaging being an operation for taking an image of the subject by the second groups of light receiving elements;
a transfer step of reading out the charges accumulated in the first groups and the second groups of light receiving elements, and transferring the charges via the first and second charge transfer lines, respectively, after the subject-illuminating imaging and the subject-non-illuminating imaging; and
an image acquisition step of acquiring an image by the subject-illuminating imaging and an image by the subject-non-illuminating imaging from the charges having been read out and transferred from the first groups and the second groups of light receiving elements, respectively.

7. The imaging method according to claim 6, wherein
the imaging step includes:
a step of causing the flash device to flash, starting an exposure on the imaging device and performing the subject-illuminating imaging;
a step of draining the charges accumulated in the second groups of light receiving elements after the subject-illuminating imaging has been finished;
a step of starting an exposure on the second groups of light receiving elements and performing the subject-non-illuminating imaging after draining the charges; and
a step of reading out and transferring the charges from the first groups and the second groups of light receiving elements through the first and the second charge transfer lines, respectively, after the subject-illuminating imaging and the subject-non-illuminating imaging has been finished.

8. The imaging method according to claim 7, further comprising a step of controlling exposure start timing of the second groups of light receiving elements such that exposure time periods of the first groups and the second groups of light receiving elements lapse at the same time.

9. The imaging method according to claim 6, wherein
the imaging step includes:
a step of causing the flash device to flash, starting an exposure on the imaging device and performing the subject-illuminating imaging;
a step of reading out the charges accumulated in the first groups of light receiving elements on the first charge transfer lines after the subject-illuminating imaging has been finished;
a step of starting an exposure on the imaging device and performing the subject-non-illuminating imaging after reading out the charges from the first groups of light receiving elements;
a step of reading out the charges from the second groups of light receiving elements after the subject-non-illuminating imaging has been finished; and
a step of transferring the charges having been read out from the first groups and the second groups of light receiving elements through via the first and the second charge transfer lines, respectively.

10. The imaging method according to claim 6, further comprising an image combining step of combining the image acquired by the subject-illuminating imaging and the image acquired by the subject-non-illuminating imaging.
